(19) United States
(12) Patent Application Publication
(10) Pub. No.: US 2020/0200435 A1
(43) Pub. Date: Jun. 25, 2020

(54) LIQUID HEATING APPLIANCE, PARITCIULARLY WATER HEATING APPLIANCE

(71) Applicant: Webasto SE, Stockdorf (DE)

(72) Inventors: Martin ZOSKE, Stockdorf (DE); Volodomyr ILCHENKO, Stockdorf (DE); Uwe STRECKER, Stockdorf (DE); Bengt MEIER, Stockdorf (DE); Nikolaus GERHARDT, Stockdorf (DE); Michael SCHWANECKE, Stockdorf (DE); Gerd FRITSCH, Stockdorf (DE)

(21) Appl. No.: 16/614,974

(22) PCT Filed: May 23, 2018
(86) PCT No.: PCT/EP2018/063521

§ 371 Date: Nov. 19, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 042.3

(51) Int. Cl. F24H 1/00; H05B 3/20; F24H 1/10; F24H 1/12; F24H 1/20; H05B 3/14

(52) U.S. Cl. CPC F24H 1/009; H05B 3/20; F24H 1/103; F24H 1/121; H05B 2203/021; H05B 3/146; H05B 2203/02; F24H 2250/04; F24H 1/202

(57) ABSTRACT

An electrical liquid heating device, in particular water heating device, preferably for a motor vehicle, including at least a first conductive layer, in particular a first metal layer, a second conductive layer, in particular a second metal layer, and a polymer layer which contains a polymer component and a conductive carbon component and is arranged between the first and the second conductive layer, wherein liquid channels for conducting the liquid, in particular water, being heated are provided which extend from a first side of the polymer layer facing the first conductive layer to a second side of the polymer layer facing the second conductive layer.

### CROSS-REFERENCE TO RELATED APPLICATIONS

This application represents the national stage entry of PCT International Patent Application No. PCT/EP2018/063521 filed on May 23, 2018 and claims priority to German Patent Application No. DE 10 2017 111 373.8 filed May 24, 2017, German Patent Application No. DE 10 2017 111 378.9 filed May 24, 2017, German Patent Application No. DE 10 2017 115 148.6 filed Jul. 6, 2017, and German Patent Application No. DE 10 2017 121 042.3 filed Sep. 12, 2017. The contents of each of these applications are hereby incorporated by reference as if set forth in their entirety herein.

### DESCRIPTION

The disclosure relates to a liquid heating device, in particular a water heating device, for a vehicle, more preferably for a motor vehicle.

Electrical water heating devices (in particular those used in mobile applications) are usually based on ceramic heating elements with a comparatively highly temperature-dependent electrical resistor by means of which self-regulation of the heat output is facilitated. These resistors are usually PTC (Positive Temperature Coefficient) elements. The elements are usually connected to heat transmission surfaces. A PTC element comprises a PTC resistance, in other words a temperature-dependent resistance, with a positive temperature coefficient which conducts the electrical current more effectively at low temperatures than at high temperatures.

Disadvantages of traditional water heating devices with ceramic PTC elements include expensive manufacture by way of a comparatively complex heat transmitter production and the installation of ceramic elements, sorting of the ceramic elements based on production tolerances which is usually necessary, a comparatively unfavourable power density in a heating element/heat transmitter network due to local heat generation, a comparatively severe restriction on maximum heat output due to the thickness of the PTC material (on account of limited heat removal from the ceramic) and also a comparatively high short-circuit risk, particularly due to there being a small geometric distance between components with a high voltage potential.

Furthermore, so-called wire heaters are known. However, wire heaters of this kind have no PTC effect and are therefore not self-regulating (which is problematic from a safety point of view).

The object of the present disclosure is therefore to propose a liquid, in particular water, heating device that facilitates effective heating of water (for mobile applications). In particular, a high power density should be achieved with a comparatively small installation space.

This problem is solved, in particular, by a liquid, preferably water, heating device according to claim 1.

In particular, the problem is solved by an electrical liquid heating device, in particular a water heating device, preferably for a vehicle, more preferably for a motor vehicle, comprising at least a first conductive layer (in particular a first metal layer), a second conductive layer (in particular a second metal layer) and a polymer layer which contains a polymer component and a conductive carbon component and is arranged between the first and the second conductive layer, wherein liquid channels for conducting the liquid, in particular water, being heated are provided which extend from a first side of the polymer layer facing the first conductive layer to a second side of the polymer layer facing the second conductive layer.

A core principle of the disclosure is that of proposing a combination of two conductive layers (metal layers) and a polymer layer arranged between the conductive layers (metal layers) having a polymer component and a conductive carbon component as an integral part (heating element) of an electrical water heating device. According to the disclosure, a comparatively large contacting surface between the conductive layers (feed lines, possibly metal plates) and the polymer layer (heat conductor layer) can be achieved, which facilitates a comparatively great power density (compared with traditional designs in which the contacting is applied to the side of the heating layer wherever possible). Overall, a high power density is achieved with an existing installation space through a comparatively high contacting surface between the conductive layers and the polymer layer. In this case, comparable safety can be achieved, as with traditional PTC water heating devices, by means of a self-regulating polymer layer (heating layer). A robust design which is comparatively easy to produce can be achieved overall. A layer structure which is similar in parts has also been described in WO 2014/188190 A1; however, not for a liquid, in particular water, heating device with corresponding liquid channels, but for a surface heater. However, liquid, in particular water, heating devices differ substantially from surface heaters in design terms, particularly due to the plurality of liquid channels provided there.

One or more (or all) of the liquid channels may extend through the first and/or second conductive layer (metal layer). Alternatively or in addition, one or more (or all) of the liquid channels may not extend through the first and/or the second conductive layer (metal layer), for example they may run at least substantially parallel to the first and/or second conductive layer (metal layer).

A liquid channel or multiple (or all) liquid channels are preferably formed at least sectionally by a (separate) pipe (in particular a metal pipe, preferably made of aluminium or an aluminium alloy). In this way, the leak-tightness and possibly heat transmission properties can, in particular, be improved. Particularly in the case of high-voltage applications, improved insulation can be achieved in that an (optionally provided) insulating layer on a (wall) surface of openings (channels) in the polymer layer is better protected by the corresponding pipe or else is separated from the liquid being heated.

The first and/or second conductive layer may be configured as a plate, in particular a metal plate, or incorporate such a plate. Alternatively or in addition, the first and/or second conductive layer (metal layer) may comprise a grid, in particular a metal grid, and/or a strip (or multiple strips), particularly made of metal.

The first and/or second conductive layer (metal layer) may have a thickness of at least 0.1 mm, preferably at least 0.5 mm, more preferably at least 1.0 mm and/or at most 5.0 mm, more preferably at most 3.0 mm.

The first and/or second conductive layer and/or the polymer layer may be (at least substantially) planar in design. If elevations or recesses are provided (apart from breakthroughs in the form of liquid channels), they may account for less than 10% of a/an (average) thickness of the respective layer.

The polymer layer may exhibit a thickness that is greater than the (average) thickness of the first and/or second conductive layer (metal layer), in particular by a factor of 1.5, preferably 2.5.

A thickness of the polymer layer may be at least 1 mm, preferably at least 3 mm and/or at most 20 mm, preferably at most 10 mm.

The thickness in each case is, in particular, an average thickness or a thickness of the largest region of the respective layer with a constant thickness.

A total of the cross sections of openings on the first and/or second conductive layer (metal layer) and/or polymer layer (for the liquid channels) may amount to at least 2%, preferably at least 5%, and/or at most 80%, preferably at most 50%, of a total cross section of the respective layer. The respective cross sections preferably relate in this case to the cross sections perpendicular to a main flow direction of the liquid or cross sections perpendicular to a thickness direction of the liquid heating device. Effective heating can be facilitated by a fraction of this kind of the cross sections of the openings defined (by the fluid channels).

The first and/or second conductive layer (metal layer) may be produced from aluminium or an aluminium alloy.

The carbon component may be arranged in such a manner that it allows a current flow, e.g. in particle form (wherein the particles touch one another accordingly or lie closely alongside one another) and/or as a carbon network.

Polymer components and the carbon components are preferably blended with one another or interwoven into one another. For example, the polymer component may form a (skeleton-like) scaffold in which the carbon component is received or vice versa.

The carbon component may be present in the form of soot and/or graphite and/or graphene and/or carbon fibres and/or carbon nano-tubes.

The carbon component preferably comprises at least 50% by wt., more preferably at least 80% by wt., still further preferably at least 90% by wt. carbon.

The polymer component is particularly configured in the form of an electrically insulating polymer component.

In embodiments, the polymer component may comprise a first polymer partial component based on ethylene acetate (copolymer) and/or ethylene acrylate (copolymer) and/or a second polymer partial component based on polyolefin, in particular polyethylene and/or polypropylene and/or polyester and/or polyamide and/or fluoropolymer. The term “partial component” should be used here, in particular, to distinguish between first and second polymer partial components. The partial component in each case may form the polymer component either partially or also completely. The ethylene acrylate may be ethyl methacrylate or ethylene ethyl acrylate. The ethylene acetate may be ethylene vinyl acetate. The polyethylene may be HD (High Density) polyethylene, MD (Medium Density) polyethylene, or LD (Low Density) polyethylene. The fluoropolymer may be PFA (copolymer of tetrafluoroethylene and perfluoropropyl vinyl ester), MFA (copolymer of tetrafluoroethylene and perfluoro-vinyl ester), FEP (copolymer of tetrafluoroethylene and hexafluoropropylene), ETFE (copolymer of ethylene and tetrafluoroethylene) or PVDF (polyvinylidene fluoride).

In embodiments the first polymer partial component may be configured as described in WO 2014/188190 A1 (as first electrically insulating material). The second polymer partial component may likewise be configured as described in WO 2014/188190 A1 (as second electrically insulating material).

The first and/or second conductive layer (metal layer) and/or the polymer layer may be configured, in principle, as described in WO 2014/188190 A1 (as first conductor, second conductor and heating element), (apart from the liquid channels according to the disclosure).

The polymer layer is preferably in contact via at least 20%, preferably at least 50%, more preferably at least 80%, of its side (without taking account of fluid channel openings) facing the first conductive layer (metal layer) with the first conductive layer (metal layer). Alternatively or in addition, the polymer layer may be in contact via at least 20%, preferably at least 50%, more preferably at least 80%, of its side (without taking account of fluid channel openings) facing the second conductive layer (metal layer) with the second conductive layer (metal layer). Through a (comparatively large) contacting surface of this kind between the conductive layers (metal layers) (metal plates) and the heating conductor layer (polymer layer), a comparatively high power density can be achieved.

The polymer layer is preferably a PTC resistor. In this way, self-regulation of the heat output is facilitated, which simplifies control and, in particular, improves safety during operation.

The polymer layer(s) and/or a corresponding paste for the production thereof may comprise at least one polymer (as a particularly crystalline binding agent), preferably based on at least one olefin; and/or at least one copolymer of at least one olefin and at least one monomer that can be co-polymerized therewith, e.g. ethylene/acrylic acid and/or ethylene/ethyl acrylate and/or ethylene/vinyl acetate; and/or at least one polyalkenamer (polyacetylene or polyalkenylene) such as, for example, polyoctenamer; and/or at least one, in particular melt-deformable, fluoropolymer, such as a polyvinylidene fluoride and/or copolymers thereof, for example.

The term “conductive” should, in principle, be understood in relation to the conductive components of the liquid heating device as an abbreviated form of “electrically conductive”.

The carbon-containing coating (in each case) is preferably a conductive layer with PTC behaviour characteristics.

The liquid heating device is preferably designed for operation in the low-voltage range (e.g. ≤100 Volt or ≤60 Volt).

Alternatively, the liquid heating device may be designed for the high-voltage range (e.g. >100 Volt, preferably >400 Volt).

The polymer layer may be covered at least partially, in particular at least in the regions of the fluid channels (or corresponding wall surfaces of the fluid channels), with an electrically insulating layer, particularly in a design intended for the high-voltage range.

The polymer layer may be added by applying a corresponding carbon heating paste. For example, this heating paste may be formed as proposed in Table I on page 11 of DE 689 23 455 T2.

In general, the carbon-containing coating or a paste used to produce the carbon-containing coating, may be formed as described in DE 689 23 455 T2. This also applies in particular to the production and/or specific composition thereof. For example, this also applies to possible binding agents (in particular according to p. 4, 2nd paragraph, and p. 5, 1st paragraph, of DE 689 23 455 T2) and/or solvents (in particular according to p. 5, 2nd paragraph and p. 6, 2nd paragraph, of DE 689 23 455 T2).

The aforementioned problem is further solved by a method for producing a liquid heating device, in particular a water heating device, preferably of the aforementioned kind, wherein a polymer layer which contains a polymer component and a conductive carbon component is arranged between a first conductive layer (in particular a first metal layer) and a second conductive layer (in particular a second metal layer), wherein liquid channels are provided for conducting the liquid to be heated, in particular water, which extend from a first side of the polymer layer facing the first conductive layer (metal layer) to a second side of the polymer layer facing the second conductive layer (metal layer). The polymer layer is preferably applied in an appropriate form to the first and/or second conductive layer (metal layer), in particular directly applied (alternatively via an intermediate layer between the polymer layer and the first or second conductive layer, in particular the metal layer).

The openings for the liquid channels may be introduced by laser cutting and/or stamping and/or produced using an extrusion and/or injection-moulding process.

The aforementioned problem is further solved by a method for operating a liquid heating device, in particular a water heating device, of the aforementioned kind, wherein liquid, in particular water, flows through the liquid channels and is thereby heated.

The aforementioned problem is further solved by the use of a liquid heating device, in particular a water heating device, of the above kind for heating liquid, in particular water, preferably in a vehicle, more preferably in a motor vehicle, more preferably for a motor vehicle interior.

An electrically conductive material should be understood to mean, in particular, a material which (at a room temperature of 25° C., in particular) has an electrical conductivity of less than 10-1 S·m−1 (possibly less than 10-8 S·m−1). Accordingly, an electrical conductor or a material (or coating) with electrical conductivity should be understood to mean a material which has an electrical conductivity of preferably at least 10 S·m−1, more preferably at least 103 S·m−1 (at a room temperature of 25° C., in particular).

Further embodiments result from the dependent claims.

The disclosure is described below with the help of an exemplary embodiment which is explained in greater detail with the help of the figures. In the figures:

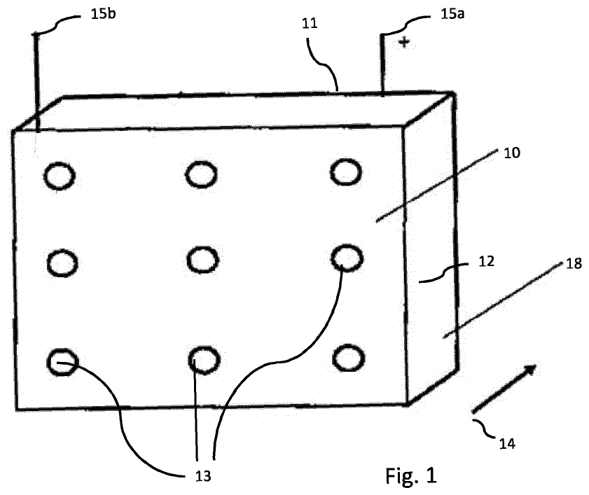

FIG. 1 shows a schematic oblique view of an electrical water heating device according to the disclosure.

In the following description, the same reference numbers are used for the same parts and parts which act in the same way.

FIG. 1 shows a schematic oblique view of an electrical water heating device according to the disclosure. This water heating device has a first conductive layer (metal layer) 10, a second conductive layer (metal layer) 11 and a polymer layer 12 (arranged therebetween). The first and second conductive layers (metal layers) are connected to electrical contacts 15a, 15b. Liquid channels 13 allow water to be conducted from a surface of the first conductive layer (metal layer) 10 facing the polymer layer 12 to a surface of the second conductive layer (metal layer) facing away from the polymer layer 12. The polymer layer is a polymer-based heating element having a carbon fraction. The polymer layer has PTC performance characteristics. An arrow 14 indicates the flow direction of the water.

The electrical heating element may have a housing 18 (preferably made of aluminium or an aluminium alloy).

Reference is made at this point to the fact that all the parts described above, taken alone and in any combination, in particular the details shown in the drawings, are claimed as essential to the disclosure. Modifications to these will be familiar to the person skilled in the art.

### LIST OF REFERENCE NUMBERS

10 first conductive layer (metal layer)
11 second conductive layer (metal layer)
12 polymer layer
13 liquid channel
14 arrow
15a contact
15b contact
18 housing

1. Electrical liquid heating device for a motor vehicle, comprising at least a first conductive layer, in particular a first metal layer, a second conductive layer, in particular a second metal layer, and a polymer layer which contains a polymer component and a conductive carbon component and is arranged between the first and the second conductive layer, wherein liquid channels for conducting the liquid, in particular water, being heated are provided which extend from a first side of the polymer layer facing the first conductive layer to a second side of the polymer layer facing the second conductive layer.

2. Liquid heating device according to claim 1,
wherein one or more of the liquid channels extend(s) through the first and/or the second conductive layer.

3. Liquid heating device according to claim 1,
wherein one or more of the liquid channels is formed at least sectionally by a pipe, wherein the respective pipe is preferably electrically insulated in respect of the electrically conductive layer.

4. Liquid heating device according to claim 1,
wherein the first and/or second conductive layer comprise(s) a plate and/or has/have a thickness of at least 0.1 mm and/or at most 5.0 mm.

5. Liquid heating device, in particular water heating device, according to claim 1,
wherein the first and/or second conductive layer and/or the polymer layer is/are at least partially planar in design.

6. Liquid heating device according to claim 1,
wherein the carbon component is present in particle form and/or as a carbon network.

7. Liquid heating device according to claim 1,
wherein the carbon component is present in the form of soot and/or graphite and/or graphene and/or carbon fibres and/or carbon nano-tubes.

8. Liquid heating device according to claim 1,
wherein the polymer component is configured in the form of an electrically insulating polymer component and/or a first polymer partial component based on ethylene acetate or ethylene acrylate copolymer and/or ethylene acrylate or ethylene acrylate copolymer and/or a second polymer partial component based on polyolefin, and/or polyester and/or polyamide and/or fluoropolymer.

9. Liquid heating device according to claim 1,
wherein the polymer layer is preferably in contact via at least 20% of its side facing the first conductive layer—without taking into account fuel channel openings—with the first conductive layer and/or via at least 20% of its side facing the second conductive layer—without taking into account fuel channel openings—with the second conductive layer.

10. Liquid heating device according to claim 1,
wherein the polymer layer is a PTC resistor.

11. Method for producing a liquid heating device according to claim 1, wherein a polymer layer which contains a polymer component and a conductive carbon component is arranged between a first conductive layer and a second conductive layer wherein liquid channels are provided for conducting the liquid to be heated which extend from a first side of the polymer layer facing the first conductive layer to a second side of the polymer layer facing the second conductive layer.

12. Method according to claim 11,
wherein the polymer layer is applied in paste form to the first and/or second conductive layer.

13. Method according to claim 11,
wherein openings for the liquid channels are introduced by laser cutting and/or stamping and/or produced using an extrusion and/or injection-moulding process.

14. Method for operating a liquid heating device according to claim 1, wherein liquid flows through the liquid channels and is thereby heated.

15. (canceled)

16. Liquid heating device according to claim 3, wherein the pipe is an aluminium pipe.

17. Liquid heating device according to claim 4, wherein the plate is a metal plate, and/or a metal grid, and/or a metal strip.

18. Liquid heating device according to claim 4, wherein the plate has a thickness of at least 1.0 mm and/or at most 3.0 mm.

19. Liquid heating device according to claim 1, wherein the polymer layer is preferably in contact via at least 80% of its side facing the first conductive layer—without taking into account fuel channel openings—with the first conductive layer and/or
via at least 80% of its side facing the second conductive layer—without taking into account fuel channel openings—with the second conductive layer.

20. Liquid heating device according to claim 1, wherein the liquid is water.

21. Liquid according to claim 8, wherein the second polymer partial component is based on polyethylene and/or polypropylene.
